(19) United States
(12) Patent Application Publication
(10) Pub. No.: US 2026/0004417 A1
(43) Pub. Date: Jan. 1, 2026

(54) TAPE AND REEL (T&R) DEFECT IMAGE REVIEW AND REBINNING SYSTEMS AND METHODS

(71) Applicant: pSemi Corporation, San Diego, CA (US)

(72) Inventors: Shweta Deora, San Diego, CA (US); John Gao, San Diego, CA (US); Doug Hawks, Paulden, AZ (US); Zhaojin Wen, San Diego, CA (US); Tuan Lam, Escondido, CA (US)

(21) Appl. No.: 18/761,225

(22) Filed: Jul. 1, 2024

(51) Int. Cl. G06T 7/00; G06T 3/40; G06T 5/50; G06V 10/24; G06V 10/762

(52) U.S. Cl. CPC G06T 7/0008; G06T 3/40; G06T 5/50; G06V 10/245; G06V 10/762; G06T 2207/20081; G06T 2207/20084; G06T 2207/20221; G06T 2207/30152

(57) ABSTRACT

Systems, methods, and computer program products for identifying defective dies at a die processing service with machine learning are provided. A training dataset comprising training images taken by one or more cameras at a tape and reel machine is provided to train a machine learning system. The training images include images of dies having integrated circuits. Positions of solder points are determined in each training image. The positions of solder points in each training image are aligned with positions of solder points in other training images to generate aligned positions of the solder points. The aligned positions are clustered into multiple clusters. A centroid position for each cluster is determined, where the centroid positions correspond to locations of the solder points across all images. The centroid positions are transmitted to the machine learning system in a production environment and are used to identify images with defective dies.

### TECHNICAL FIELD

The disclosure generally relates to detecting die defects, and more specifically to using machine learning for detecting die defects using images taken at a die processing service.

### BACKGROUND

A die is a portion of a wafer that includes an integrated circuit. A wafer may include multiple dies. The dies are separated from a wafer using a wafer saw. The separated dies are placed in carrier tape using a tape and reel machine.

During processing or separation some dies may become damaged. Tape and reel machines may collect and package these damaged dies and then ship them to customers.

Tape and reel machines may include cameras. These cameras take images of the dies, including damaged dies. What are needed are systems and methods for analyzing the images of the dies to detect damaged or defective dies.

### BRIEF DESCRIPTION OF THE DRAWINGS

FIG. 1 is an exemplary computing environment where embodiments may be implemented.

FIG. 2 is a block diagram of a machine learning system during a training stage, according to some embodiments.

FIGS. 3A-B are diagrams of images of dies, according to some embodiments.

FIGS. 4A-D are diagrams illustrating how images of dies are aligned, according to some embodiments.

FIG. 5 is a block diagram of a machine learning system during an inference stage, according to some embodiments.

FIGS. 6A-B are diagrams illustrating how a defective die is identified, according to some embodiments.

FIG. 7 is a flowchart of a method for training a machine learning system, according to some embodiments.

FIG. 8 is a flowchart of a method for identifying a defective die using a machine learning system, according to some embodiments.

FIG. 9 is a diagram illustrating defective dies having a crack, according to some embodiments.

FIG. 10 is a block diagram of a machine learning system during a training stage, according to some embodiments.

FIG. 11 is a block diagram of a machine learning system during an inference stage, according to some embodiments.

FIG. 12 is a flowchart of a method for training a machine learning system, according to some embodiments.

FIG. 13 is a flowchart of a method for identifying a defective die using a machine learning system, according to some embodiments.

FIG. 14 is a block diagram of a computer system suitable for implementing one or more components or operations in FIGS. 1-13 according to an embodiment.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

A die processing service includes cameras that collect images of dies. Most of those images are images of good dies, and some are of defective dies. To detect images of the defective dies, the embodiments are directed to machine learning systems trained to detect different types of defective images. For example, one machine learning system may be trained to analyze images and detect missing solder points in the dies. A solder point may be a solder bump, solder pad, solder contact, and the like in an integrated circuit. Another machine learning system may be trained to analyze the images and detect images of cracked dies. The trained machine learning systems may be communicatively connected to the die processing service and receive images of the dies in real-time or at predetermined intervals. When one of machine learning systems detects images that include defective dies, the machine learning system may generate an alert. The alert may identify the defective die, and a tape and reel machine that is associated with the defective die, which may facilitate the removal of the defective die from the packaging process.

Further, the embodiments are directed to extensible machine learning systems that may be trained to identify additional or specific die defects and then be connected to the die processing service to identify those defects.

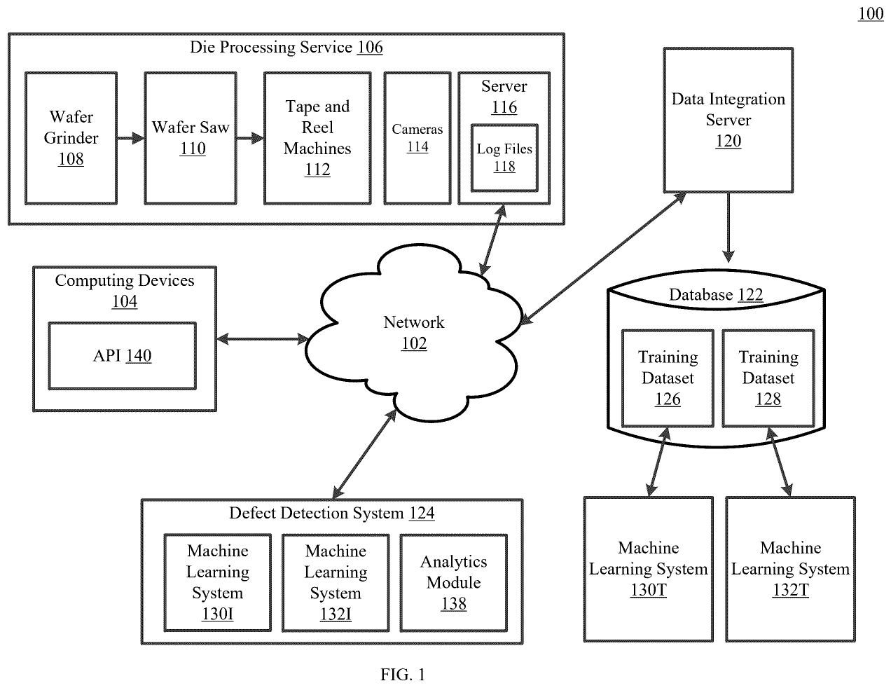

FIG. 1 is an exemplary system 100 where embodiments can be implemented. System 100 may be a computing environment or a computing system. System 100 includes a network 102. Network 102 may be implemented as a single network or a combination of multiple networks. For example, in various embodiments, network 102 may include the Internet or one or more intranets, landline networks, wireless networks, and/or other appropriate types of networks. Network 102 may be a small-scale communication network, such as a private or local area network, or a larger scale network, such as a wide area network.

Various components that are accessible to network 102 may be computing device(s) 104 and die processing service 106. Computing devices 104 may be portable and non-portable electronic devices under the control of a user and configured to transmit, receive, and manipulate data from over network 102. Example computing devices 104 include desktop computers, laptop computers, tablets, smartphones, wearable computing devices, eyeglasses that incorporate computing devices, implantable computing devices, etc.

Die processing service 106 may be a system of hardware machines and servers that are coupled physically or communicatively to generate separated dies (components) from wafers. Die processing service 106 may include one or more wafer grinder(s) 108, wafer saw(s) 110, and tape and reel machine(s) 112. Wafer grinder(s) 108 may reduce a thickness of a wafer in a semiconductor fabrication process before the wafer saw(s) 110. The wafer saw(s) 110 may cut the wafer into separate the dies. The tape and reel machine(s) 112 may place the dies on the carrier tape prior to shipping them to various entities.

Die processing service 106 may include one or more cameras 114. Cameras 114 may be included in or communicatively connected to tape and reel machines 112. Cameras 114 may be different types of cameras, such as cameras that have flipper vision, BUMP vision, near infrared (NIR) camera, etc. Cameras 114 may take images of dies as tape and reel machines 112 place dies on a reel or during another process in die processing system 106.

In some instances, images of dies may include die defects. Example defects may include die contamination, a missing solder point on a die, a die crack, or a die chip. There may be one or more defects within a single die. Some defects, such as cracks, may also indicate potential issues with neighboring dies. The die contamination may be a pin mark or a die collision on an image of a die and may be an indication to scrape the reel. A missing solder point may correspond to a missing connection point between the integrated circuit and other components, and may be indicative of a further investigation into the die. A die chip may be a chip in a corner of the die, and may be indicative of a further investigation of the die. A die crack may be indicative of a further investigation into the die and neighboring dies that may also have been impacted by the die crack or neighboring dies that have a crack.

Die processing service 106 may also include a server 116. Server 116 may be an electronic device configured for large scale data processing and service, and may include a physical computer, a server program, or the like, that facilitates data collection and processing. Server 116 may include log files 118. Log files 118 may be text files, image files, or a combination of both. Log files 118 may store images of dies taken by cameras 114, camera logs, reel identifiers that correspond to the reels associated with tape and reel machines 112, and pocket information, such as pocket identifiers that correspond to pockets where the dies are placed. In some instances, log files 118 may be specific to one tape and reel machine, or may include data from multiple tape and reel machines 112 in die processing service 106. Notably, the embodiments are also applicable to collecting images at other types of machines within the die processing service 106, such as automated optical inspection (AOI) machines, post module build AOI machines, and post saw AOI machines.

Server 116 may be connected to network 102. Using network 102, server 116 may transmit the data in log files 118 to data integration server 120. Data integration server 120 may be a computing device or a server program that processes and aggregates data from multiple log files 118. Data integration server 120 may standardize data in log files 118 into a common file, remove corrupted data, and the like. Additionally, data integration server 120 may also run image brightening or darkening algorithms on the images, as needed. Once data integration server 120 processes the data in log files 118, data integration server 120 may store data in database 122 or another memory storage conducive for storing and retrieving large amounts of data. Additionally, or alternatively, data integration server 120 may transmit the data to defect detection system 124 in real-time or at predefined time increments for identifying defective images as discussed below.

In some instances, database 122 may store data from log files 118 over several days, weeks or years. Some or all data stored in database 122 may be included in training datasets 126, 128 for training machine learning systems 130, 132. In some instances, training dataset 126, 128 may store images specific to certain types of defects. The images may be historical images collected over several months or years. For example, training dataset 126 may include images from cameras 114 that include dies with missing solder points and images of good dies without missing solder points, while training dataset 128 may include images from cameras 114 that include images of dies with cracks and images of good dies without cracks. In other instances, training datasets 126, 128 may include the same images in their training datasets. Notably, training datasets 126, 128 are not limiting, and other training datasets may be created for other types of defects.

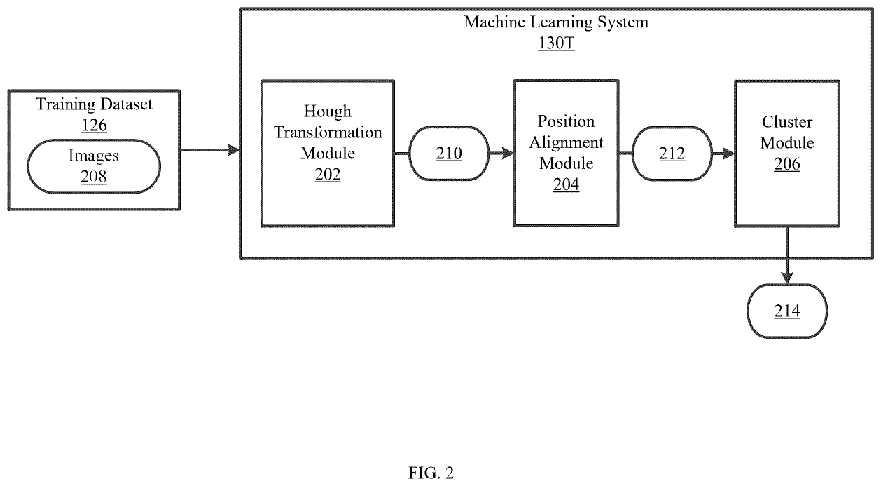

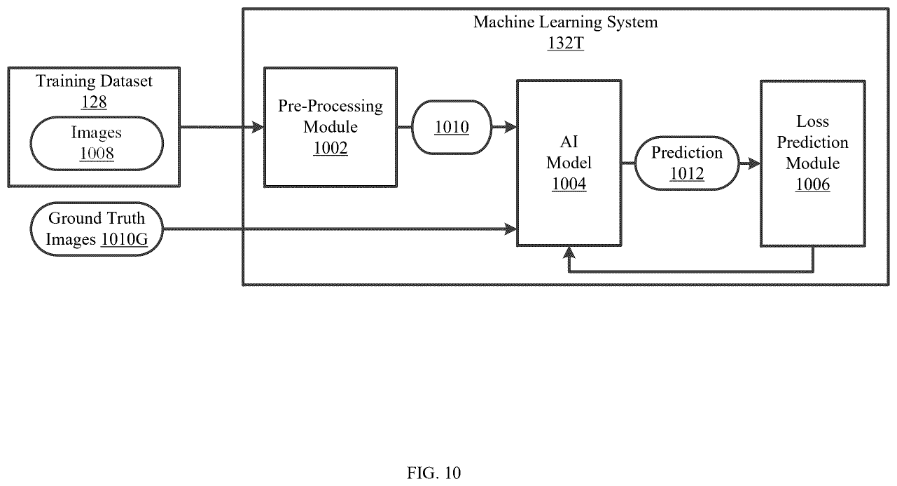

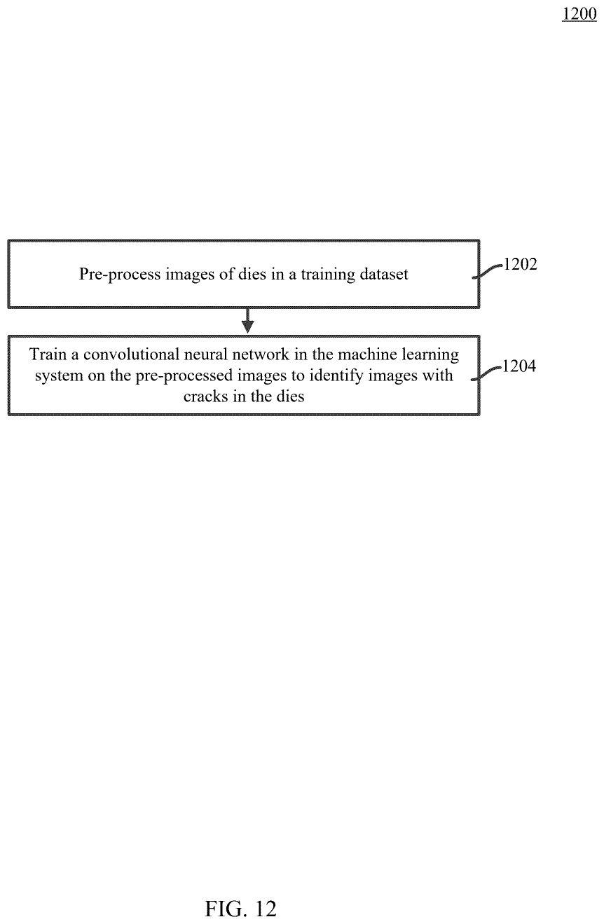

Machine learning systems 130, 132, may be trained to identify different die defects. To identify die defects, machine learning systems 130, 132 may be trained on training datasets 126, 128, where each training dataset may be specific to a corresponding die defect. During the training stage, machine learning systems 130, 132 may be referred to as machine learning systems 130T, 132T, respectively. The training stage of machine learning system 130T is discussed in further detail in FIGS. 2-4A-D, and 7. The training stage of machine learning system 132T is discussed in further detail in FIGS. 10 and 12.

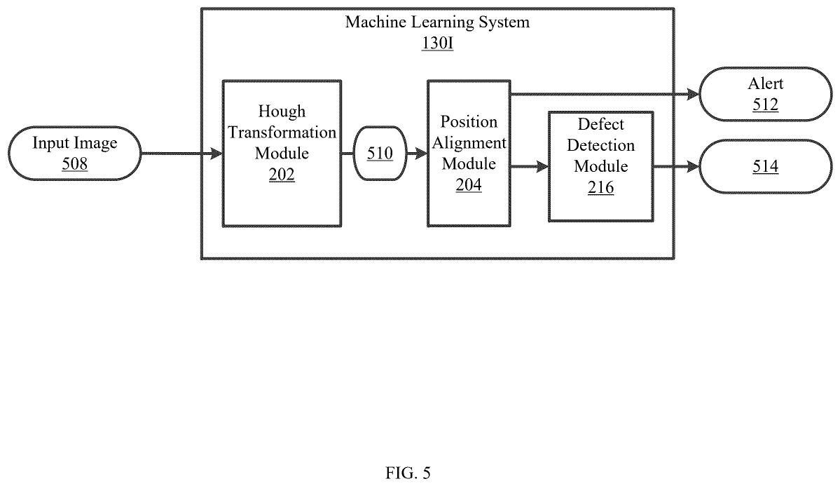

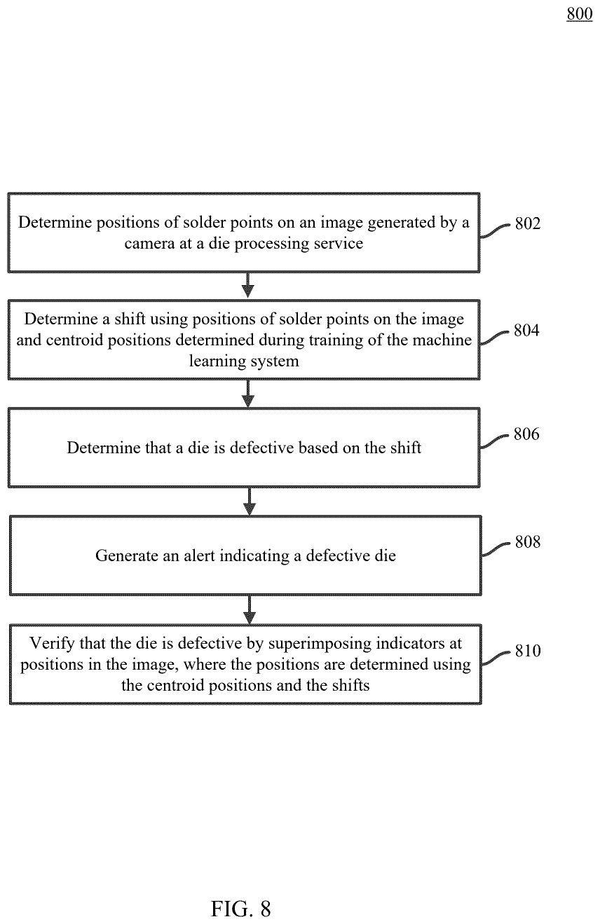

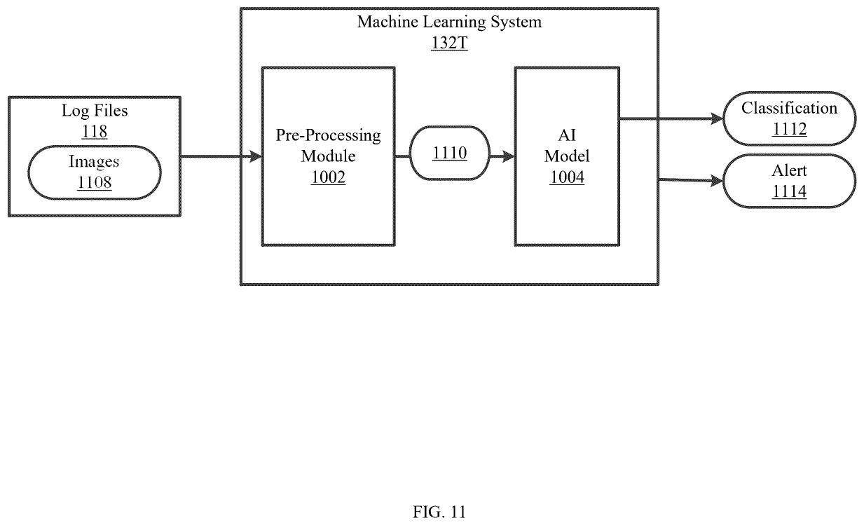

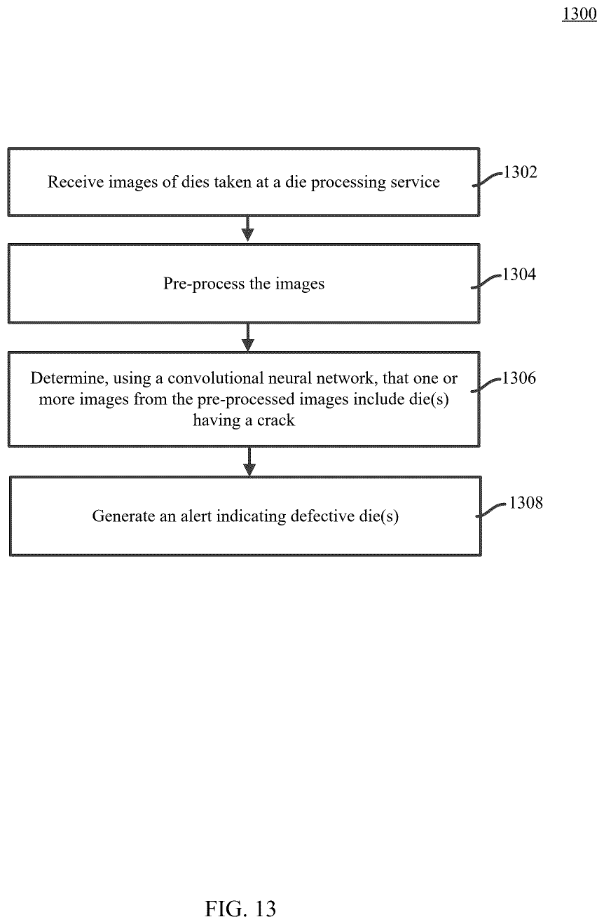

Once machine learning systems 130, 132 are trained, machine learning systems 130, 132 may enter an inference stage. During the inference stage, machine learning system 130, 132, referred to as machine learning systems 130I, 132I respectively, may be placed in computing environment 100 to identify die defects that occur in die processing service 106 in real-time or at predefined time intervals. The inference stage of machine learning system 130I is discussed in further detail in FIGS. 5 and 8. The inference stage of machine learning system 132I is discussed in further detail in FIGS. 11 and 13.

In non-limiting embodiments, machine learning system 130 may identify die defects that include missing solder points on a die, while machine learning system 132 may identify die defects that include cracks in a die. Notably, other machine learning systems may be trained to identify other types of defects, such as die contamination, chips on a die, and the like. Further, the machine learning systems discussed herein are extensible, as the machine learning systems may be swapped in and out of computing environment 100, based on specific needs of die processing service 106 for identifying different types of die defects.

Defect detection system 124 may be software or a combination of software components that detect die defects. Defect detection system 124 may include multiple machine learning systems, such as machine learning systems 130I, 132I, that are trained to identify different die defects, including missing solder points on a die and cracked dies. Machine learning systems 130I, 132I may operate together or individually to detect die defects in die processing service 106. Further, additional machine learning systems may be added or removed to detect die defects or other errors in die processing service 106.

In some instances, defect detection system 124 may receive data from log files 118 that die processing service 106 generates in real-time or at predefined time intervals. The data may be received over network 102 and extracted from log files 118 in real-time or at predefined time intervals. In other instances, defect detection system 124 may receive data from data integration server 120 that has processed and synchronized data from log files 118.

In some instances, defect detection system 124 may include an analytics module 138. Analytics module 138 may analyze the defective dies identified by machine learning systems 130I, 132I, and use log files 118 to identify the source of the defective image, such as a particular tape and reel machine 112, the reel (e.g., via a reel identifier), and the pocket (e.g., via the pocket identifier) that corresponds to the defective die. Analytics module 138 may also determine whether some tape and reel machine(s) 112 have more defective dies than others, and based on the types of defects, recommend a corrective action. For example, analytics module 138 may track defective dies that may be detected using machine learning system 130I and determine that one of tape and reel machines 112 generates dies with missing solder points more often than other tape and reel machines 112. Analytics module 138 may generate an alert with a remediation action, a graph that depicts the frequency of the defective dies, location of the missing solder points, and the like. In another example, analytics module 138 may track defective dies that may be detected using machine learning system 132I, such as cracks in the dies. Analytics module 138 may also identify tape and reel machine 112 associated with the cracked dies and identify neighboring dies to the cracked die that may also be affected by the crack. Analytics module 138 may generate an alert indicating the existence of the crack in the die and/or the neighboring dies. Similarly, analytics module 138 may track the frequency with which machine learning system 132I detects the cracked dies at a corresponding tape and reel machine 112, and generate an alert with a remedial action that may take place for reducing the frequency or a graph illustrating the frequency of the cracks in the dies. In another example, analytics module 138 may analyze defective dies detected by machine learning systems 130I, 132I and generate analytics that summarize the number of defective dies generated by die processing service 106, particularly tape and reel machine 112, possible remediation actions, and the like. The alerts from analytics module 138 may be encapsulated into message for transmission to an application interface (API) 140.

Computing device 104 may include API 140. API 140 may display alerts and/or data generated using machine learning systems 130I, 132I, and analytics module 138. In some instances, alerts or messages from defect detection system 124 may activate API 140, or cause computing device 104 to emit an audible sound indicating an alert from defect detection system 124. An example alert may include tape and reel machine 112 that includes a die with a defect, a location of the die defect on the tape and reel machine 112, such as the reel identifier and the block identifier, and/or action that may be taken to correct the die defect or minimize the effect of the die defect. An example action may be to scrape the reel in case of die contamination, further investigation of the die in case of a missing solder point or a chip, and/or further investigation into a die and neighboring dies in case of a die crack.

Although the embodiments discussed below pertain to training and using machine learning system 130 to detect dies with missing solder points and training and using machine learning system 132 to detect dies with cracks, the embodiments are not limiting, and other machine learning systems may be similarly trained to identify different types of die defects.

FIG. 2 is a block diagram 200 of a machine learning system 130 trained to identify a defective die, according to some embodiments. Machine learning system 130T may include a Hough transformation module 202, a position alignment module 204, and a clustering module 206. Machine learning system 130T may be trained on training dataset 126 that includes images 208 to identify missing solder points in images 208. Images 208 may include good images (e.g., images without missing solder points) and bad images (e.g., images with missing solder points). During the training stage, machine learning system 130T is trained on images 208 of dies to identify positions of the solder points in the integrated circuits included in the dies.

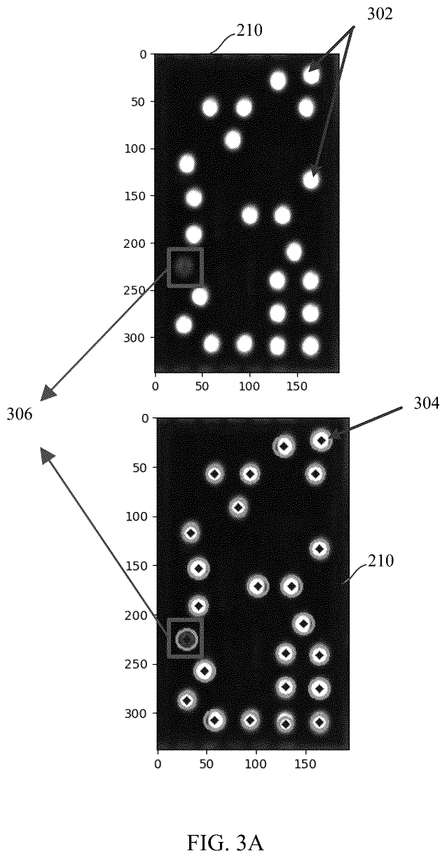

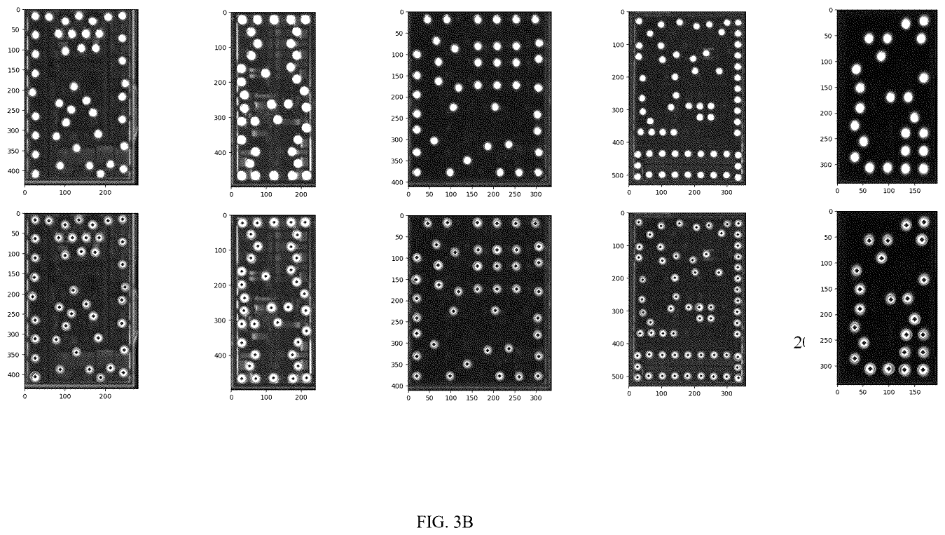

Hough transformation module 202 may apply a Hough transform to images 208 in training dataset 126 to generate images 210. The Hough transform detects features, such as shapes, within images 208. Example features may be circles, lines, ellipses, and the like. For example, Hough transform may detect and highlight features, such as circles, which correspond to solder points of an integrated circuit depicted in images 208. FIGS. 3A-B are diagrams 300A-B of images generated by a Hough transformation module, according to some embodiments. FIG. 3A depicts images 210 that were processed by Hough transformation module 202. The Hough transformation module 202 detected the solder points as circles 302 and circles 304 that include a centroid in the middle of each circle 304. As illustrated in FIG. 3A areas that have missing solder points (e.g., images of defective dies) may not be highlighted, and are shown as gray circles 306. Accordingly, for multiple images 208 of dies having the same integrated circuit layout, if there is a pixel difference (e.g., a pixel difference between white and gray pixels) above a predetermined threshold in images 210 at the same position, the pixel difference is indicative of a missing solder points, and a defective die.

FIG. 3B illustrates that Hough transformation module 202 may process different types of images 208 that correspond to different integrated circuits, such that machine learning system 130T is trained to recognize good and defective dies in images 208 that correspond to different integrated circuits. FIG. 3B also illustrates solder points in different images 210 that are detected using Hough transformation module 202.

Going back to FIG. 2, position alignment module 204 may align multiple images 310 of dies having the same integrated circuit layout. As one or more cameras 114 take pictures of dies, which are converted to images 208, dies in images 208 may be slightly shifted. The shift may depend on the position of the camera, time when the picture is taken, and other factors. Accordingly, to determine the location of solder points across multiple images 210, position alignment module 204 may align circles 302, 304, in images 210 that were generated using Hough transformation module 202 into centroid positions 212.

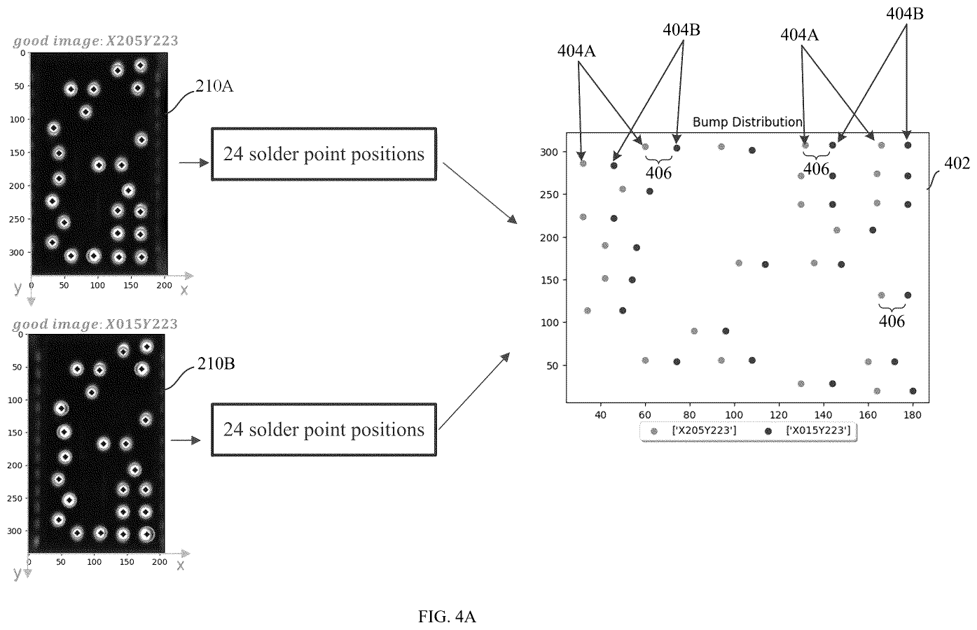

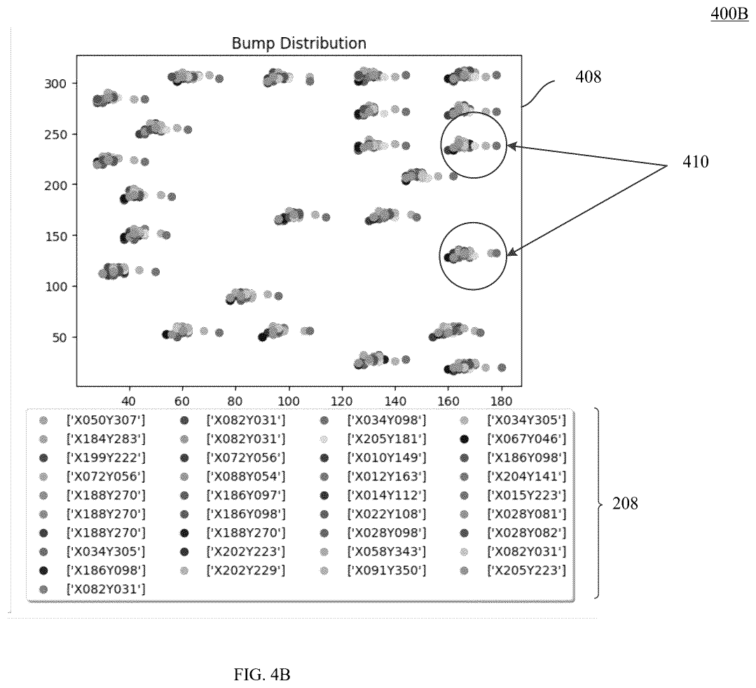

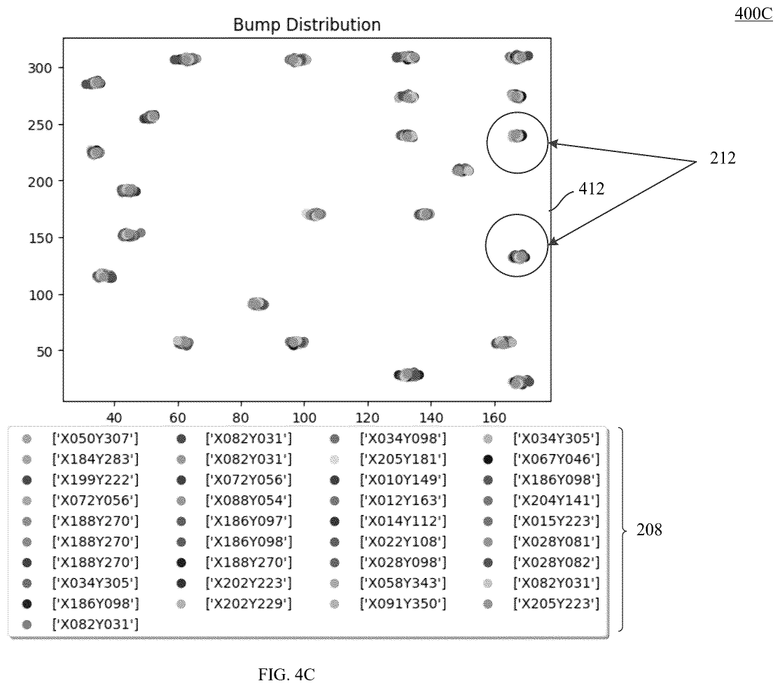

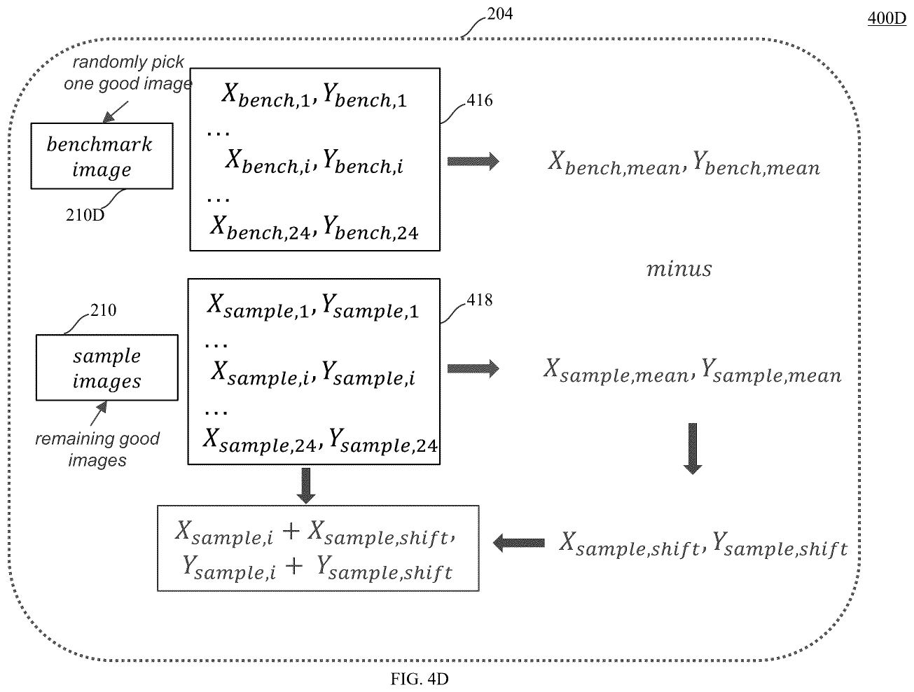

FIGS. 4A-D are block diagrams 400A-D illustrating how position alignment module 204 aligns images 210, according to some embodiments. FIG. 4A illustrates a distribution of solder points in images 210A and 210B. For example, Hough transformation module 202 or position alignment module 204 may use the circles 302, 304 in images 210 to identify a centroid in the center of each circle, such as e.g., by determining a diameter (or an approximate diameter in case the shape is an approximation of a circle) and dividing the diameter by two. Position alignment module 204 may then generate a graph 402 of a distribution of the centroids 404A and 404B from the respective images 210A and 210B. As illustrated in FIG. 4A, the centroids 404A and 404B are shifted from each other by an approximate shift 406.

Position alignment module 204 may generate a graph of distribution of the centroids from multiple images 210 that correspond to the same integrated circuit. FIG. 4B illustrates a distribution 408 that includes centroids representing solder points from multiple images 210. In FIG. 4B, the positions of multiple centroids, such as positions 410, from images 210 corresponds to positions of corresponding solder points in the die. FIG. 4B illustrates that multiple images 210 are shifted from each other by different shifts.

To reduce the shifts, position alignment module 204 may align the solder points in different images 210 by adjusting the centroids at positions 410 of each image 210 by a uniform position range. FIG. 4C illustrates a graph of a distribution 412 that includes centroid positions 212 of adjusted centroids of images 210 by a uniform position range. FIG. 4D illustrates an algorithm for adjusting the centroids at positions 410 of images 210 by a uniform range to obtain the graph of distribution 412 shown in FIG. 4C.

FIG. 4D illustrates how the position alignment is accomplished, according to some embodiments. As illustrated in FIG. 4D, position alignment module 204 may randomly select a benchmark image 210 that passed through Hough transformation module 202, such as image 210D, and identify centroid positions 416 of the solder points in image 210D. Example centroid positions 416 may be designated using (X,Y) coordinates with respect to the image (or another type of coordinates). Next, position alignment module 204 may determine centroid positions 418 of the solder points of the remaining images 210. Position alignment module 204 than determines shifts between centroid positions 416 of image 210D and centroid positions 418 of the remaining images 210 for each solder point by subtracting centroid positions 418 from centroid positions 416. Position alignment module 204 then determines the mean of the shifts for each solder point and adds the mean of the shifts to centroid positions 418. Upon completion, position alignment module 204 may align the centroids of images 210 as shown in FIG. 4C into centroid positions 212.

Clustering module 206 may identify a number of solder points in images 210. Clustering module 206 may implement a K-means clustering algorithm or another algorithm to determine clusters. The K-means clustering algorithm partitions the data space, which may be centroids positions 212 of images 210 into k clusters, such that each centroid position 212 corresponds to the nearest mean of the cluster. The centroid positions 214 of each cluster may be represented as (X_{centroid,i}, Y_{centroid,i}), where i corresponds to the solder points in images 210. In some instances, the hyperparameter k that corresponds to the number of clusters may be set based on a type of the integrated circuit in the dies depicted in images 210. For example, if an integrated circuit includes 24 solder points, then k may be set to 24.

The output of clustering module 206 may be a data structure that includes centroid positions 214 of each cluster and corresponds to a position of each solder point across multiple images 210. The images 210 correspond to dies having the same integrated circuit, where i=1 to k.

Machine learning system 130T may be trained on training dataset 126 that includes images 208 of different integrated circuits to recognize the location of solder points in the integrated circuits. Once trained, machine learning system 130T (or parameters that correspond to machine learning system 130T) may be stored in defect detection system 124 as machine learning system 130I.

Going back to FIG. 1, during an inference stage, machine learning system 130I may receive log files 118 or images included in log files 118 from die processing service 106 or data integration server 120. Machine learning system 130I may detect whether an image generated at die processing service 106 in real-time includes a defective die, such as a die with a missing solder point. FIG. 5 is a block diagram 500 of a machine learning system 130I for detecting a defective die, according to some embodiments. Machine learning system 130I may receive image 508, which may be an image taken at die processing service 106 in real-time or within a predefined time interval.

Machine learning system 130I may pass image 508 through Hough transformation module 202 to detect features that correspond to positions of the solder points or solder points in image 508. As discussed above, example features may be circles or other shapes detected in image 508. The image 508 that passed through Hough transformation module 202 may be image 510. Position alignment module 204 may use the output of the Hough transformation module 202 to determine the locations of the solder points in image 510, such as (X_{image,i}, Y_{image,i}), where i=1 to k and corresponds to each solder point. Next, position alignment module 204 may determine a mean of the solder points in image 510, e.g., (X_{image,mean}, Y_{image,mean}) by averaging the positions of locations of the solder points in image 510, e.g., (X_{image,i}, Y_{image,i}) from i=1 to k. The position alignment module 204 may determine the shift (X_{image,shift}, Y_{image,shift}) of image 510 by subtracting the mean centroid positions (X_{centroid,mean}, Y_{centroid,mean}) of each solder point determined by averaging the centroid positions 214 determined during the training stage from the mean positions of the solder points, e.g., (X_{image,mean}, Y_{image,mean}). If the die in image 508 is defective, e.g., the solder point does not exist, the pixel value at mean position will be significantly different from a pixel value at the mean position with a good die, indicating a defective die. The significant difference may be predetermined or pre-set, and may be greater than a predetermined number of pixels. If a defective die is detected, machine learning system 130I may generate an alert 512 that may be transmitted to API 140 of FIG. 1.

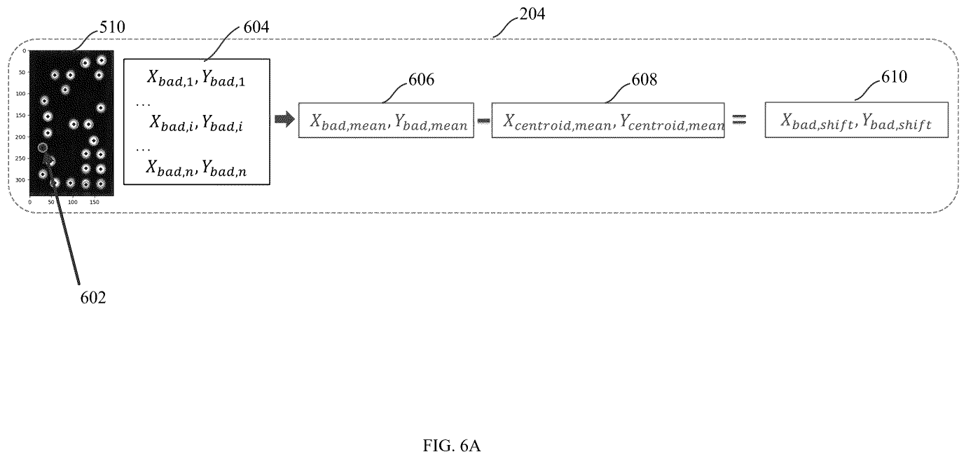

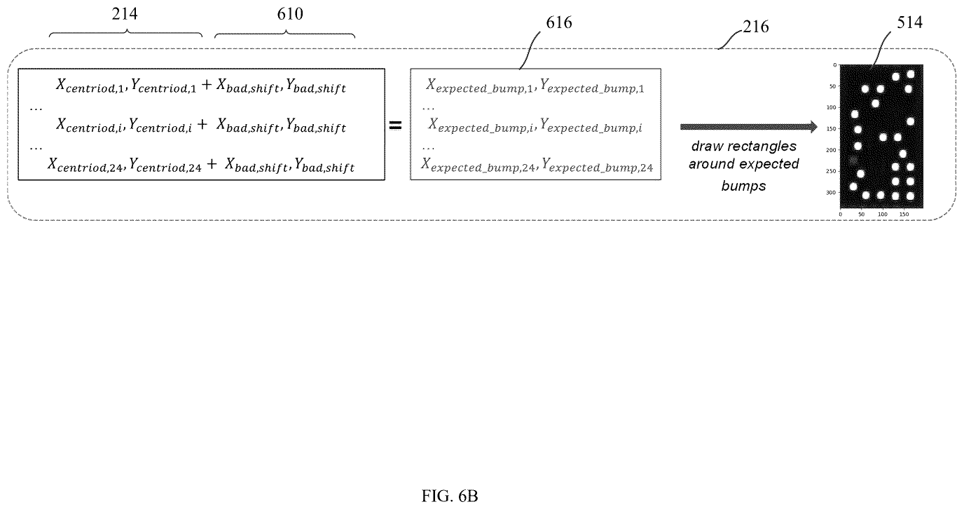

For example, suppose image 508 includes a defective die with a missing solder point. FIG. 6A is a block diagram 600A illustrates position alignment module 204 identifying a defective die, according to some embodiments. FIG. 6A illustrates image 510 that includes a defective die, which is image 508 passed through Hough transformation module 202. As shown in FIG. 6A, image 510 includes a missing solder point 602. Position alignment module 204 identifies positions 604 of the solder points in image 510, designated as (X_{bad,i}, Y_{bad,i}) from i=1 to k, where k is the number of solder points. Next, position alignment module 204 determines mean positions 606 from positions 604. As part of this process, position alignment module 204 determines a shift 610 in image 510 by subtracting mean centroid positions 608 (X_{centroid,mean}, Y_{centroid,mean}) from mean positions 606. Shift 610 may be designated as (X_{bad,shift}, Y_{bad,shift}). Because image 508 includes a defective solder point, the shift 610 may cause a pixel value at the mean position to be significantly different from a pixel value at the mean position with a good die.

Going back to FIG. 5, machine learning system 130I may also include a defect detection module 216. Defect detection module 216 may receive or access centroid positions (X_{centroid,i}, Y_{centroid,i}) of each solder point as generated by K-clustering module 206. The centroid positions (X_{centroid,i}, Y_{centroid,i}) are associated with images 208 in training dataset 126 that correspond to dies having the same integrated circuit as image 508. Defect detection module 216 may receive the shift (X_{image,shift}, Y_{image,shift}) of image 508 (which may be shift 610) and add the shift (X_{image,shift}, Y_{image,shift}) to the centroid positions 214 (X_{centroid,i}, Y_{centroid,i}) to determine an expected locations (X_{expected bump,i}, Y_{expected bump,i}) of the solder points in image 508 and identify missing solder points when the pixel position of expected locations (X_{expected bump,i}, Y_{expected bump,i}) significantly varies from the centroid positions 214 (X_{centroid,i}, Y_{centroid,i}). In some instances, defect detection module 216 may also superimpose the indicators of the expected positions of the solder points on image 508 to generate superimposed image 514. For example, defect detection module 216 may draw indicators such as squares or other geometric shapes at the expected locations (X_{expected bump,i}, Y_{expected bump,i}) of the solder points to generate superimposed image 514. Defect detection module 216 may then generate an alert that includes superimposed image 514 or incorporates superimposed image 514 into alert 512 for transmission to API 140 of FIG. 1. In this way, defect detection module 216 may visually indicate a location of missing solder point in image 508.

In some instances, defect detection module 216 may generate superimposed images 514 for images 508 that visually indicate whether images 508 are defective.

FIG. 6B is a block diagram 600B illustrating defect detection module 216 identifying a defective die, according to some embodiments. As illustrated in FIG. 6B, defect detection module 216 may use centroid positions 214 (e.g., (X_{centroid,i}, Y_{centroid,i}) of each solder point as determined by clustering module 206 and shift 610 (e.g., shift (X_{bad,shift}, Y_{bad,shift})) of image 508 to determine expected positions 616 (e.g., (X_{expected bump,i}, Y_{expected bump,i})) of solder points in image 508. Defect detection module 216 may then draw indicators, e.g., squares or rectangles at the expected positions 616 to generate superimposed image 514. Because there may be significant pixel variation between centroid positions 214 (e.g., (X_{centroid,i}, Y_{centroid,i}) and expected positions 616, the one or more indicators in superimposed image 514 will not be in the same location as the one or more centroid positions 214, which may visually indicate a defective die in image 508.

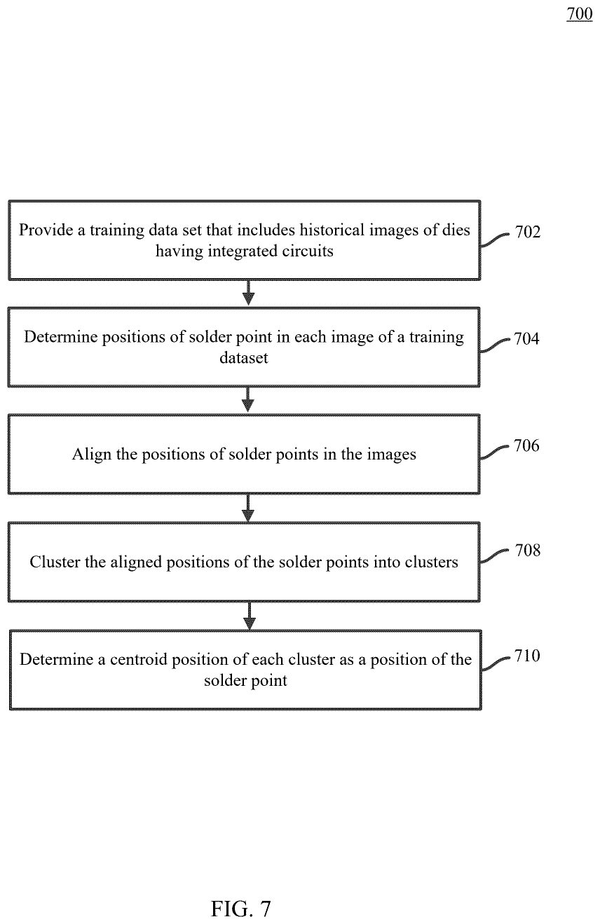

FIG. 7 is a flowchart of a method 700 for training a machine learning system, according to some embodiments. Notably, method 700 is exemplary and other methods may also be used. Method 700 may be performed using hardware and/or software components described in FIGS. 1-6A-B. Note that one or more of the operations may be deleted, combined, or performed in a different order as appropriate. Method 700 may be performed for each type of integrated circuit depicted in images 208.

At operation 702, a training dataset is provided. For example, machine learning system 130T may access training dataset 126 that includes images 208. Images 208 may be training images of dies taken by cameras 114 at one or more tape and reel machines 112. The training images may be historical images that were taken by cameras 114 over a period of several months or years. The dies may include integrated circuits.

At operation 704, positions of solder points in images of a training dataset are determined. For example, Hough transformation module 202 may perform a Hough transformation on images 208 which highlights certain features in images 208. Example features may be solder points which may be highlighted as circles 302 or circles 304 with centroids. The images with features may be images 210.

At operation 706, positions of solder points in images 208 are aligned. For example, position alignment module 204 may align positions of solder points in multiple images 310 into centroid positions 212 as discussed in FIGS. 4A-4D. The alignment may reduce the shift 406 that may occur when images 208 of dies are taken by cameras 114.

At operation 708, clusters of solder points are generated from the aligned positions of solder points in images 210. For example, clustering module 206 may determine clusters of the solder points from the centroid positions 212 generated by position alignment module 204.

At operation 710, centroid positions of the clusters are determined. For example, for each cluster, clustering module 206 may determine the centroid positions 214. Centroid positions 214 may correspond to the solder points across multiple images 210.

FIG. 8 is a flowchart of a method 800 for determining a die defect using a machine learning platform, according to some embodiments. Notably, method 800 is exemplary and other methods may also be used. Method 800 may be performed using hardware and/or software components described in FIGS. 1-6A-B. Note that one or more of the operations may be deleted, combined, or performed in a different order as appropriate. Method 800 may occur in real time or at predefined intervals to detect defective dies in die processing service.

At operation 802, positions of solder points in an image is determined. For example, Hough transformation module 202 may perform a Hough transformation on images 508 taken by camera 114 in die processing service 106. As discussed in FIG. 3A, Hough transformation module 202 may generate image 510 that includes shapes, such as circles, that correspond to solder points. The image 508 may be part of log file 118 that defect detection system 124 received from die processing service 106 or data integration server 120.

At operation 804, a shift is determined. For example, position alignment module 204 may determine a shift 610 between the positions of solder points in image 510 and mean centroid positions 608 determined from centroid positions 214 during the training stage.

At operation 806, a defective image is determined. For example, when image 508 includes a defective solder point, the shift 610 may result in a pixel value at the mean positions to be significantly different from a pixel value at the mean positions when image 508 is a good image.

At operation 808, an alert is generated. For example, if image 508 is determined to include a defective die, machine learning system 130I may generate alert 512 that may be transmitted to API 140. Additionally, alert 512 may also indicate a tape and reel machine 112 that generated the defective die, as well as a reel identifier and a pocket identifier of the defective die.

At operation 810, a missing solder point is verified. For example, defect detection module 216 may use the centroid positions 214 and shift 610 to determine expected positions 616 of the solder points in image 510. Defect detection module 216 may generate image 514 that includes image 510 with shapes, such as circles or squares, superimposed on image 510 at expected positions 616 to verify the locations of solder points on image 510. If a solder point is missing, image 514 may include a shape that is superimposed at a location where the solder point is missing.

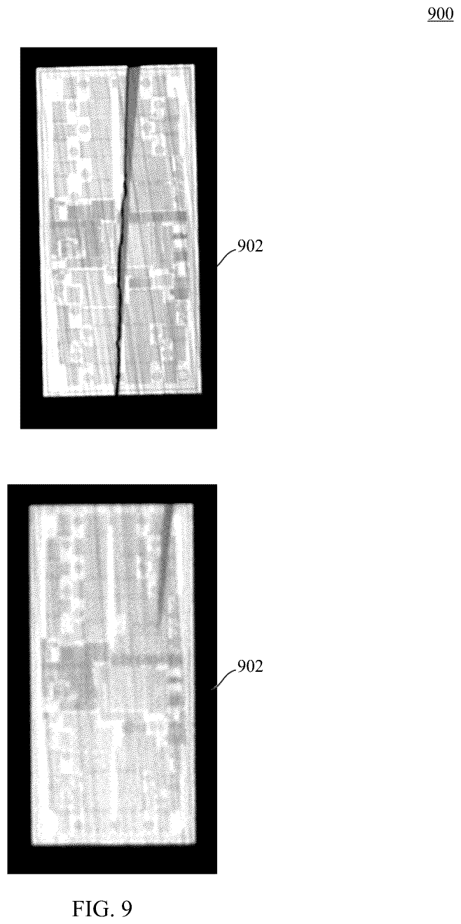

Going back to FIG. 1, machine learning system 132T may be trained to identify die defects that include dies with one or more cracks. To identify dies with one or more cracks, machine learning system 132T may be trained on training dataset 128 that includes good images of dies without cracks and images of cracked dies. FIG. 9 is a diagram 900 illustrating various images of cracked dies, according to some embodiments. The images of cracked dies 902 shown in FIG. 9 may be included in training dataset 128.

FIG. 10 is a diagram 1000 of a machine learning system 132 trained to identify a defective die, according to some embodiments. Machine learning system 132T may include a pre-processing module 1002, an artificial intelligence (AI) model 1004 and a loss prediction module 1006.

Machine learning system 132 may receive training dataset 128 with images 1008. Images 1008 may be training images that include good images of dies and bad images of cracked dies. Training images may be historical images that were taken by camera 114 over the past several months or years. Images 1008 may have been collected over a period of months or years, and stored in training dataset 128.

Pre-processing module 1002 may receive images 1008 and perform pre-processing techniques on images 1008. For example, pre-processing module 1002 may pass images 1008 through a contrast enhancing module that may increase or decrease the brightness between different objects in the image. For example, contrast enhancing module may increase the brightness such that some objects in the image, e.g., cracks, may stand out compared to other objects in the image. Contrast enhancing module may also enhance or reduce influence of die patterns within image 1008 to more accurately identify cracks. Pre-processing module 1002 may also crop image 1008, such that the a die, and not the background, is included in the image. For example, pre-processing module 1002 may crop images 1008 such that the central die is visible in the image while the rest of the image is cropped. Pre-processing module 1002 may also resize the cropped images, such that the cropped images are all the same size. The output of pre-processing module 1002 may be preprocessed images 1010. Notably, the pre-processing techniques above are not limiting, and additional pre-processing techniques may be added to or be removed from pre-processing module 1002. In some embodiments, pre-processing module 1002 may be external to machine learning system 132T.

AI model 1004 may be an artificial neural network (ANN), convolutional neural network (CNN), or another type of neural network conducive to processing and classifying image data. AI model 1004 may include multiple layers, including an input layer, hidden layers, and an output layer. Each layer may comprise neurons that are interconnected according to a specific topology. The neurons may be associated with weights and activation functions. The values of the weights may change as the machine learning system 1004T is trained. The input layer receives the input data, such as images 1010 and ground truth image(s) 1010G. Hidden layers are intermediate layers between the input and the output layer of the neural network. Hidden layers receive input data processed by the input layer and may extract and transform the input data through a series of weighted computations that correspond to the weights and activation functions at each neuron in the hidden layers. The activation function may be same or different across different layers. Example activation functions may include Sigmoid, hyperbolic tangent, Rectified Linear Unit (ReLU), Leaky ReLU, Softmax, and/or the like.

The output of the hidden layers is passed as input to an output layer. The output layer generates a prediction 1012 which is a classification of the input data. The output layer may be a classification layer or a softmax layer. Example prediction 1012 may be a binary classification by a classification layer or a probability classification by a softmax layer. In the binary classification, prediction 1012 may indicate whether a die in each image in images 1010 includes or does not include a defect, such as a crack, as compared to ground truth image 1010G. In a probability classification, prediction 1012 may indicate a probability that the die in each image in images 1010 is the same (does not include a crack) or different (includes a crack) as ground truth image 1010G.

In the ANN, the input layer, hidden layers, and the output layer may be fully connected layers. In the fully connected layers the neurons of one layer may be fully connected to neurons of the subsequent layers. Each layer may include the same or different number of neurons as the proceeding layer. However, because the neurons are fully connected, when AI model 1004 receives images 1010, 1010G are converted into image vectors at an input layer and are acted upon and propagated through all neurons of ANN until the output layer generates prediction 1012, making ANN computationally expensive.

In some instances, because using ANN may be computationally expensive, AI model 1004 may include a CNN. An example CNN may be a ResNet 18 model that may be pre-trained on an image dataset and/or including images with cracks and then finetuned using images 1010. A CNN may include one or more convolution layers and pooling layers, followed by fully connected layers, and an output layer. The first convolution layer may be an input layer. The remaining convolution layers, pooling layers, and fully connected layers may be hidden layers. The convolution layers and pooling layers may be interspersed among each other and may be collectively referred to as feature layers. The first convolution layer (e.g., the input layer) may receive images 1010 and ground truth images 1010G, whereas other convolutional layers may receive the output of the preceding convolutional layer or the output of a pooling layer.

The convolutional layers perform series of convolution operations on the images. The convolutional operations include applying a number of convolutional filters on the input images at each neuron (e.g., using weights), adding bias, and applying one of non-linear activation functions discussed above. The convolutional layers may extract features from the input images, such as edges, patterns, color, gradient orientation, and the like. Typically, the output of convolutional layers may have a lesser dimension than input images or the output of the preceding layers, but may have more depth.

The pooling layers reduce dimensionality of the input, thus reducing the number of parameters in the input, which in turn reduces a number of computations in the CNN and increases efficiency. Essentially, the pooling layers combine parameters in the received input into a single parameter. A pooling layers may be a maximum pooling layer or an average pooling layer. The maximum pooling layer may identify a maximum value of a portion of an input into the pooling layer, while the average pooling layers may identify an average of a portion of the input. Same or different pooling layers may be interspersed among the convolutional layers in the CNN.

The output of the convolutional layer or pooling layer (whichever is last), may be fed into a first fully connected layer in the fully connected layers. There may be multiple fully connected layers in the CNN. Each neuron in the first fully connected layer receives the output of the convolutional layer or pooling layer as input and processes the input via weights and an activation function as discussed above. The output of the first fully connected layer may be passed to the next fully connected layer, and so on until an output layer is reached. There may be fewer number of neurons in each subsequent fully connected layer than in the preceding layers. Further, each fully connected layer may have the same or different activation function.

The output layer, which may be a classification layer or a softmax layer may receive the output of the last fully connected layer and generate prediction 1012, as discussed above.

Loss prediction module 1006 may receive prediction 1012 and determine whether prediction 1012 is correct with respect to images 1010 or ground truth image 1010G. In particular, images 1010 or ground truth image 1010G may include labels that identify images 1010, 1010G that include and do not include cracked dies. Loss prediction module 1006 may compare prediction 1012 to the labels of images 1010 or ground truth images 1010G and identify whether prediction 1012 correctly classified images 1010 or ground truth image 1010G, as well as the cost of error. To determine the cost of error, loss prediction module 1006 may use a cost or loss function (e.g., a binary, a categorical, such as ReLU cost function, etc.,) associated with a type of classification. As the AI model 1004 is trained over multiple iterations of images 1010 and ground truth image 1010G, loss prediction module 1006 attempts to minimize the cost of error using a back propagation algorithm.

The back propagation algorithm may be a gradient descent algorithm, including a stochastic gradient descent, gradient descent with Adam, gradient descent with momentum, or the like. The back propagation algorithm may receive the cost of error and may determine a change in value that may be applied to the weights of the neurons in the convolutional layers, pooling layers, and fully connected layers, such that the cost of error across training dataset 128 is minimized. The loss prediction module 1006 propagates the change in value of the weights in the neurons back into AI model 1004.

In some embodiments, machine learning system 132T may receive input images 1008 and ground truth images 1010G in training dataset 128 over thousands or millions iterations. The training may continue until AI model 1004 generates predictions 1012 with a cost of error below a cost of error threshold. Once trained, machine learning system 132T may be validated using a validation dataset. The validation dataset may be a portion of training dataset 128, e.g., twenty percent of the training dataset 128 that includes images 1010 that were not included in training machine learning system 132T. Machine learning system 132T may receive the validation dataset and generate predictions 1012 for the images 1010 in the validation dataset. The predictions 1012 for images 1010 may then be compared against labels of images 1010 using loss prediction module 1006. Alternatively, predictions 1012 may be transmitted for display to API 140 of FIG. 1 (not shown), and validated using API 140. Notably, during the validation stage, the loss prediction module 404 may not propagate changes to the weights to the neurons of AI model 1004.

Once machine learning system 132T is trained to determine die defects, such as cracks, machine learning system 132 may be included in defect detection system 124 of FIG. 1 as machine learning system 132I.

FIG. 11 is a block diagram 1100 of machine learning system 132I, according to some embodiments. Machine learning system 132I may be machine learning system 132 that was trained using training dataset 128 to identify cracks in images of dies. Machine learning system 132I may receive weights of neurons of AI model 1004 from machine learning system 132T. These weights may be set to the corresponding neurons in AI model 1004 of machine learning system 132I but otherwise have little to no value for other systems.

Machine learning system 132I may receive or request real-time data from die processing service 106 images in log files 118 or images from data integration server 120. The images may be received via network 102 in real-time or at predefined time increments (e.g., every second, every minute, etc.). Additionally, machine learning system 132I may also receive log files 118 with data associated with images 1108.

As discussed above, machine learning system 132 is trained to identify cracks in dies displayed in images 1008. Machine learning system 132I may retrieve images 1108 from log files 118 and pass images 1108 through pre-processing module 1002 to generate images 1110 that may be cropped, sized, and include enhanced contrast of the objects depicted in images 1108. AI model 1004 may pass images 1110 through the convolutional neural network to determine whether images 1110 include cracks in the dies. AI model 1004 may classify images 1110 with a true/false classification 1112 that indicates whether images 1110 include crack(s) or with a score that indicates the likelihood of the crack(s). When the classification indicates that image 1110 includes a crack, machine learning system 132I generates an alert 1114.

Going back to FIG. 1, API 140 may receive alerts, such as alerts 512, images 514, and alerts 1114 generated using machine learning systems 130I and 132I. API 140 may display the alerts 512, 1114 and images 514 on a display screen of computing device 104. In some instances, API 140 may activate once computing device 104 receives alerts 512, 1114 or images 514. In other embodiments, computing device 104 may issue an audible alert upon receipt of alerts 512, 1114 or images 514.

FIG. 12 is a flowchart of a method 1200 for training a machine learning system, according to some embodiments. Notably, method 1200 is exemplary and other methods may also be used. Method 1200 may be performed using hardware and/or software components described in FIGS. 1, 9-10. Note that one or more of the operations may be deleted, combined, or performed in a different order as appropriate.

At operation 1202, images in the training dataset are pre-processed. For example, pre-processing module 1002 may receive images 1008 and perform one or more pre-processing techniques to generate images 1010. Example pre-processing techniques may be contrast enhancing techniques to enhance cracks, if any, compared to other objects in images 1010, image cropping techniques, such that image 1010 includes image of a die without other extraneous information, and resizing the cropped image, such that dies in images 1010 are the same size.

At operation 1204, machine learning system is trained. For example, machine learning system 132T may be trained using images 1010 or a portion of images 1010 over thousands or millions iterations. During training, images 1010 may be passed through the layers of AI model 1004 of machine learning system 132T until AI model 1004 learns to generate predictions 1012 that classify images 1010, 1010G as images with and without cracks in a die. As discussed above, during training, the weights of the neurons in AI model 1004 may be modified using backtracking algorithm to minimize error over training dataset 128 as identified by a cost function.

FIG. 13 is a flowchart of a method 1300 for using a machine learning system to identify dies with cracks according to some embodiments. Notably, method 1300 is exemplary and other methods may also be used. Method 1300 may be performed using hardware and/or software components described in FIGS. 1, 9-10. Note that one or more of the operations may be deleted, combined, or performed in a different order as appropriate.

At operation 1302, images of dies are received. For example, defect detection system 124 may receive images 1108 of dies taken by one or more cameras 114 at die processing service 106. Images 1108 may be received in log files 118 from die processing service 106 or data integration server 120 in real-time or at predefined time intervals. Additionally, data that is associated with images 1108, such as the tape and reel machine 112, the reel identifier and a pocket identifier associated with the images 1108 may also be received.

At operation 1304, images are pre-processed. For example, images 1108 are pre-processed using one or more pre-processing techniques into images 1110. The pre-processing may facilitate identification of cracks that may exist in dies displayed in one or more images 1108. Example pre-processing techniques may be contrast enhancing techniques, cropping images 1108 such that the dies, and not the background, are displayed in the cropped images, and resizing the cropped images such that the cropped images are the same or approximately the same size.

At operation 1306, a crack in one or more images is identified. For example, AI model 1004 of machine learning system 132I may receive images 1110 and generate classification 1112 for each image 1110. The classification 1112 may indicate whether the die in the corresponding image includes a crack.

At operation 1308, an alert is generated. For example, if one of images 1110 is classified to include a crack, machine learning system 132I may generate an alert 1114 that may be transmitted to API 140. The alert 1114 may indicate that a die includes a crack, may include an image in images 1110 that corresponds to the crack, may indicate a tape and reel machine 112 that generated the die with a crack, as well as a reel identifier and a pocket identifier of the defective die.

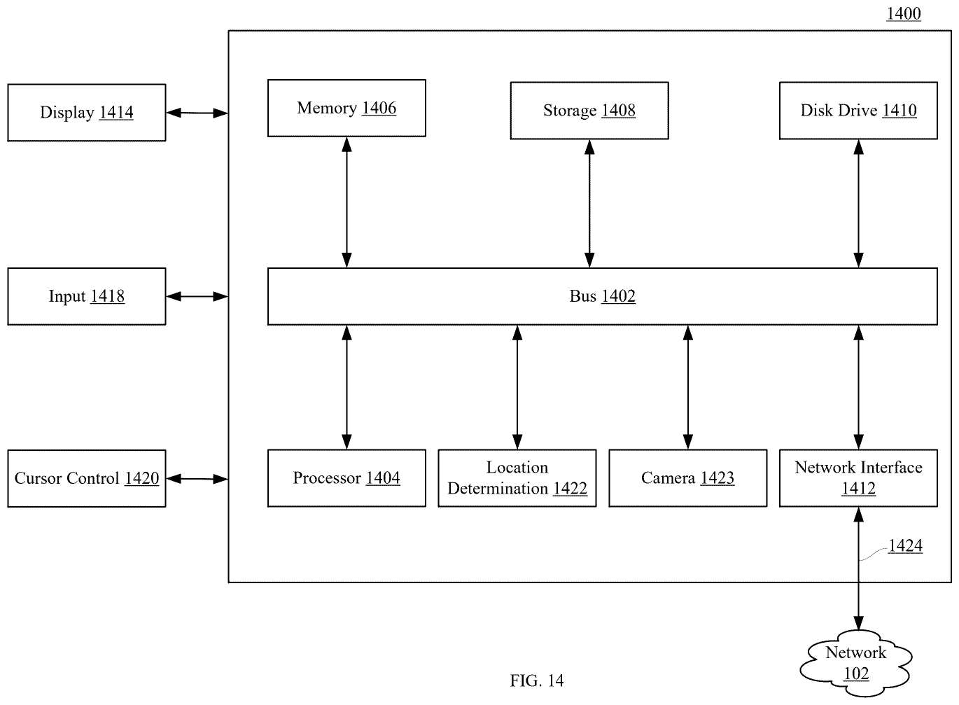

Referring now to FIG. 14 an embodiment of a computer system 1400 suitable for implementing, the systems and methods described in FIGS. 1-13 is illustrated.

In accordance with various embodiments of the disclosure, computer system 1400, such as a computer and/or a server, includes a bus 1402 or other communication mechanism for communicating information, which interconnects subsystems and components, such as a processing component 1404 (e.g., processor, micro-controller, digital signal processor (DSP), graphics processing unit (GPU), etc.), a system memory component 1406 (e.g., RAM), a static storage component 1408 (e.g., ROM), a disk drive component 1410 (e.g., magnetic or optical), a network interface component 1412 (e.g., modem or Ethernet card), a display component 1414 (e.g., CRT or LCD), an input component 1418 (e.g., keyboard, keypad, or virtual keyboard), a cursor control component 1420 (e.g., mouse, pointer, or trackball), a location determination component 1422 (e.g., a Global Positioning System (GPS) device as illustrated, a cell tower triangulation device, and/or a variety of other location determination devices known in the art), and/or a camera component 1423. In one implementation, the disk drive component 1410 may comprise a database having one or more disk drive components.

In accordance with embodiments of the disclosure, the computer system 1400 performs specific operations by the processor 1404 executing one or more sequences of instructions contained in the memory component 1406, such as described herein with respect to the mobile communications devices, mobile devices, and/or servers. Such instructions may be read into the system memory component 1406 from another computer readable medium, such as the static storage component 1408 or the disk drive component 1410. In other embodiments, hard-wired circuitry may be used in place of or in combination with software instructions to implement the disclosure.

Logic may be encoded in a computer readable medium, which may refer to any medium that participates in providing instructions to the processor 1404 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1410, volatile media includes dynamic memory, such as the system memory component 1406, and transmission media includes coaxial cables, copper wire, and fiber optics, including wires that comprise the bus 1402. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the disclosure, execution of instruction sequences to practice the disclosure may be performed by the computer system 1400. In various other embodiments of the disclosure, a plurality of the computer systems 1400 coupled by a communication link 1424 to the network 102 (e.g., such as a LAN, WLAN, PTSN, and/or various other wired or wireless networks, including telecommunications, mobile, and cellular phone networks) may perform instruction sequences to practice the disclosure in coordination with one another.

The computer system 1400 may transmit and receive messages, data, information and instructions, including one or more programs (i.e., application code) through the communication link 1424 and the network interface component 1412. The network interface component 1412 may include an antenna, either separate or integrated, to enable transmission and reception via the communication link 1424. Received program code may be executed by processor 1404 as received and/or stored in disk drive component 1410 or some other non-volatile storage component for execution.

Where applicable, various embodiments provided by the disclosure may be implemented using hardware, software, or combinations of hardware and software. Also, where applicable, the various hardware components and/or software components set forth herein may be combined into composite components comprising software, hardware, and/or both without departing from the scope of the disclosure. Where applicable, the various hardware components and/or software components set forth herein may be separated into sub-components comprising software, hardware, or both without departing from the scope of the disclosure. In addition, where applicable, it is contemplated that software components may be implemented as hardware components and vice-versa.

Software, in accordance with the disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the disclosure to the precise forms or particular fields of use disclosed. As such, it is contemplated that various alternate embodiments and/or modifications to the disclosure, whether explicitly described or implied herein, are possible in light of the disclosure. Having thus described embodiments of the disclosure, persons of ordinary skill in the art will recognize that changes may be made in form and detail without departing from the scope of the disclosure. Thus, the disclosure is limited only by the claims.

What is claimed is:

1. A system comprising:
a non-transitory memory storing instructions; and
one or more hardware processors coupled to the non-transitory memory and configured to read the instructions from the non-transitory memory to cause the system to perform operations comprising:
providing a training dataset comprising a plurality of training images taken by one or more cameras at a tape and reel machine, wherein the plurality of training images are of dies having integrated circuits;
determining, using a transformation module, positions of solder points in each training image in the training images:
aligning the positions of solder points in the each training image with positions of solder points in other training images in the plurality of training images to generate aligned positions;
clustering, using a clustering module, the aligned positions into a plurality of clusters; and
determining centroid positions from the plurality of clusters, wherein the centroid positions correspond to solder points in the plurality of training images.

2. The system of claim 1, wherein the transformation module performs a Hough transform on the plurality of training images to generate a plurality of transformed images with the positions of solder points represented as circular indicators.

3. The system of claim 2, wherein generating the aligned positions further comprises:
selecting a transformed image from the plurality of transformed images as a benchmark image;
determining a shift using the benchmark image and other transformed images in the plurality of transformed images; and
adjusting the other transformed images by the shift to generate the aligned positions.

4. The system of claim 1, wherein the clustering module uses a K-means clustering algorithm to generate the plurality of clusters.

5. The system of claim 1, further comprising:
receiving an image of a die, the image taken by a camera at a die processing service;
transforming, using the transformation module, the image into a transformed image, wherein the transformed image includes positions of solder points of the die in the image; and
determining, using the centroid positions and the positions of the solder points in the transformed image that the image includes a defective die, wherein the defective die includes a missing solder point.

6. The system of claim 5, wherein the determining further comprising:
determining a shift between the centroid positions and the positions in the transformed image; and
determining the image as including the defective die when the shift is above a predefined threshold.

7. The system of claim 6, further comprising:
determining, using the shift and the centroid positions, expected positions of the solder points; and
superimposing indicators at the expected positions in the transformed image to generate a superimposed image.

8. The system of claim 7, further comprising:
displaying the superimposed image, wherein an indicator in the superimposed image of the defective die indicates an expected position of the missing solder point.

9. A method comprising:
determining positions of solder points on an image of a die, wherein the image is generated by a camera at a die processing service;
determining, using a machine learning system, a shift between the positions of the solder points in the image and centroid positions determined during training of the machine learning system; and
determining, using the shift, that the die in the image is a defective die.

10. The method of claim 9, wherein the camera is at a tape and reel machine.

11. The method of claim 9, wherein determining the positions of the solder points further comprises:
transforming the image into a transformed image, wherein the transformed image includes features indicating the solder points; and
determining, using the features, the positions of the solder points.

12. The method of claim 9, further comprising:
receiving the image in real-time or within a predetermined time period after being generated by the camera at the die processing service.

13. The method of claim 9, further comprising:
determining, using the shifts and the centroid positions, expected positions of the solder points; and
superimposing indicators at the expected positions on the image of the die.

14. The method of claim 13, further comprising:
generating an alert including an indication of the defective die and the superimposed image.

15. The method of claim 9, wherein the centroid positions are determined using training images of dies that have the same layout of an integrated circuit as the image of the die.

16. A non-transitory machine-readable medium having stored thereon machine-readable instructions executable to cause a machine to perform operations comprising:
providing a training dataset comprising training images taken by one or more cameras at a tape and reel machine, wherein the training images are of dies having integrated circuits;
pre-processing the training images; and
training, using the pre-processed training images, a convolutional neural network comprising feature layers and fully connected layers to identify cracks in the dies in the training images, wherein the feature layers and the fully connected layers comprise neurons associated with corresponding weights and wherein the training comprises:
passing each image in the pre-processed training images through the feature layers and the fully connected layers to generate a corresponding prediction indicating whether the each image includes a die with or without a crack;
determining a prediction error for the each image, wherein the prediction error indicates the prediction is a true prediction or a false prediction; and
modifying the weights of the neurons in the convolutional neural network until prediction errors are minimized.

17. The non-transitory machine-readable medium of claim 16, wherein the pre-processing further comprises:
cropping at least one image in the training images to center the die included in the at least one image.

18. The non-transitory machine-readable medium of claim 16, wherein the pre-processing further comprises:
resizing at least one image in the training images such that the at least one image is the same size as other resized images in the training images.

19. The non-transitory machine-readable medium of claim 16, wherein the pre-processing further comprises:
passing the training images through a contrast enhancing algorithm, wherein the contrast enhancing algorithm enhances at least one crack in the training images.

20. The non-transitory machine-readable medium of claim 16, further comprising:
receiving an image of a die taken at a tape and reel machine; and
passing, the image through the convolutional neural network, to determine that the image depicts a defective die or a non-defective die, wherein the defective die includes a crack in the die.
